(19) United States
(12) Patent Application Publication
(10) Pub. No.: US 2014/0164903 A1
(43) Pub. Date: Jun. 12, 2014

(54) SYSTEM AND METHOD FOR ORGANIZING AND CROSS-REFERENCING DATA TO ENABLE DYNAMIC DISPLAY AND REAL-TIME EDITING OF DATA IN A FLEXIBLE USER INTERFACE

(71) Applicant: Memorial e Libraries, Inc., Cape Coral, FL (US)

(72) Inventors: Edward F. Paquette, Cape Coral, FL (US); Brandon Roberson, Cape Coral, FL (US); Karl Schwaerzle, Bonita Springs, FL (US); Michael Richards, North Fort Meyers, FL (US); Henry Miller, Cape Coral, FL (US); Kyle Jalbert, Cape Coral, FL (US)

(73) Assignee: Memorial e Libraries, Inc., Cape Coral, FL (US)

(21) Appl. No.: 13/937,626

(22) Filed: Jul. 9, 2013

Related U.S. Application Data
(60) Provisional application No. 61/670,065, filed on Jul. 10, 2012.

(51) Int. Cl. G06F 17/24; G06F 17/22

(52) U.S. Cl. CPC G06F 17/24; G06F 17/2247
USPC 715/234

(57) ABSTRACT

Computer-implemented methods and systems are provided for creating web-based books simulating the experience of reading a physical book. The web-based books are directly editable by users in real-time.

### CROSS REFERENCE TO RELATED APPLICATION

This application claims priority from U.S. Provisional Patent Application No. 61/670,065 filed on Jul. 10, 2012 entitled SYSTEM AND METHOD FOR ORGANIZING AND CROSS-REFERENCING DATA TO ENABLE DYNAMIC DISPLAY AND REAL-TIME EDITING OF DATA IN A FLEXIBLE USER INTERFACE, which is hereby incorporated by reference.

### BACKGROUND

Companies have marketed various types of web-based books with content such as text and pictures. Users access these web-based books on the internet and can usually flip through pages of the book by clicking a particular location on the page. In this manner, the user is provided with an interaction that mimics the experience of reading a physical book.

In order to provide real-time book functions, such as turning a page, as well as other functions such as zooming and resizing text, companies have developed web-based books in code such as JAVA and ADOBE FLASH. These types of code require the user to install plug-ins that allow for functionality such as turning pages without having to refresh the browser. Other types of code, like HTML, that do not require plug-ins are typically not used because they do not provide a similar level of control over the rendering and animation that is performed in the web-based books. Furthermore, using JAVA or FLASH allows programmers to avoid various browser bugs and platform-specific concerns.

While JAVA and FLASH may be advantageous for existing web-based books, they lack the tools needed to create a more dynamic, more accessible web-based book. First, web-based books constructed in JAVA or FLASH generally display static content. In other words, once a book has been constructed in the browser, the content on each page cannot be directly edited (e.g., upload, add, delete, change) by a user. Because of this issue, existing web-based books typically display static content for viewing only, and do not allow its readers to add or alter content.

Another major disadvantage to using JAVA or FLASH is that any content (textual or graphical) rendered through these applications cannot be indexed by internet search engines such as Google, Yahoo, etc. Accordingly, a user cannot search for a specific web-based book, or particular content in the book, using a search engine. Instead, the user has to first know about the website that hosts the books, navigate to that website, and then search for a specific book or page. Given the copious amounts of information on the internet, such a system would be extremely inefficient for researching information, and it is like unlikely that a user would utilize both a search engine and a web-based book for research.

Yet another disadvantage to using JAVA or FLASH is that their applications are not supported by all browsers. JAVA and FLASH applications require plug-ins, and therefore are usually accessed by desktop browsers. While these plug-ins are extremely useful for providing important functionalities for the application, such as page turning, these JAVA-based and FLASH-based applications are not flexible enough to be supported by all browsers. In addition to desktop browsers that do not include plug-ins, mobile devices provide very little support for these plug-ins as well, and FLASH support is unlikely on many mobile phones. Given the ubiquitous use of mobile phones, as well as the fact that more and more people access the internet via their mobile phones, a JAVA-based or FLASH-based application would not provide the best user-interface.

An application written in HTML would solve many of the problems caused by JAVA-based and FLASH-based applications. For example, HTML allows users to upload pictures and edit text on a webpage. HTML also allows for content to be indexed by search engines so that content rendered from the HTML application can be searchable by a standard search engine. Lastly, HTML is flexible enough to be supported on all browsers, including mobile browsers and browsers that do not require plug-ins.

However, existing HTML programs are not robust enough to provide the same level of control over the rendering and animation as JAVA and FLASH. Furthermore, HTML does not provide the real-time interactions, such as flipping a page without reloading the browser, that can be provided by JAVA-based or FLASH-based applications. These disadvantages are clear from the fact that existing web-based books are not programmed in HTML, but rather in JAVA or FLASH. What is needed is a platform that leverages the advantages of plug-in based architectures, such as JAVA and FLASH, with the advantages of HTML.

### BRIEF SUMMARY OF THE DISCLOSURE

In accordance with one or more embodiments, a method is provided for creating a web-based book simulating the experience of reading a physical book. The web-based book is directly editable by a user in real-time. The method includes the steps of: (a) rendering a webpage of the web-based book by a server computer system in response to a request received over a communications network from a client device operated by a user, said webpage having an HTML-based format; (b) sending the webpage to the client device to be displayed by a web browser on the client device; (c) receiving one or more edits made by the user on the webpage; and (d) updating the web-based book in real-time to include the edits.

In accordance with one or more further embodiments, a server computer system comprises at least one processor, memory associated with the at least one processor, and a program supported in the memory for creating a web-based book simulating the experience of reading a physical book. The web-based book is directly editable by a user in real-time. The program contains a plurality of instructions which, when executed by the at least one processor, cause the at least one processor to: (a) render a webpage of the web-based book in response to a request received over a communications network from a client device operated by a user, said webpage having an HTML-based format; (b) send the webpage to the client device to be displayed by a web browser on the client device; (c) receive one or more edits made by the user on the webpage; and (d) update the web-based book in real-time to include the edits.

### BRIEF DESCRIPTION OF THE DRAWINGS

FIG. 1 illustrates an exemplary network in which a web-based book platform in accordance with one or more embodiments may be implemented.

FIG. 2 is a simplified block diagram illustrating components of the web-based book platform in accordance with one or more embodiments.

FIGS. 3-9 are examples of screenshots displayed to a user creating a web-based book in accordance with one or more embodiments.

### DETAILED DESCRIPTION

Various embodiments disclosed herein are directed to a web-based book platform for organizing and cross-referencing data to enable dynamic display and real-time editing of data in a flexible user interface. The platform includes a database and a user-interface. The database can be configured to receive data both from an outside source and from the platform's users. The database then cross-references all of its data based on relationships provided by the platform's users. The user-interface of the platform selectively displays this data and corresponding relationships via a web-based book simulation, but in a manner that is both dynamic and flexible. Specifically, the user-interface maintains known functionalities of web-based book simulations, such as page turning and content re-sizing, but then adds dynamic features such as real-time editing on each page by adding, deleting, uploading, or changing data. The web-based book interface also provides flexibility by being configured to render data that is both searchable by a search engine and supported by all browsers.

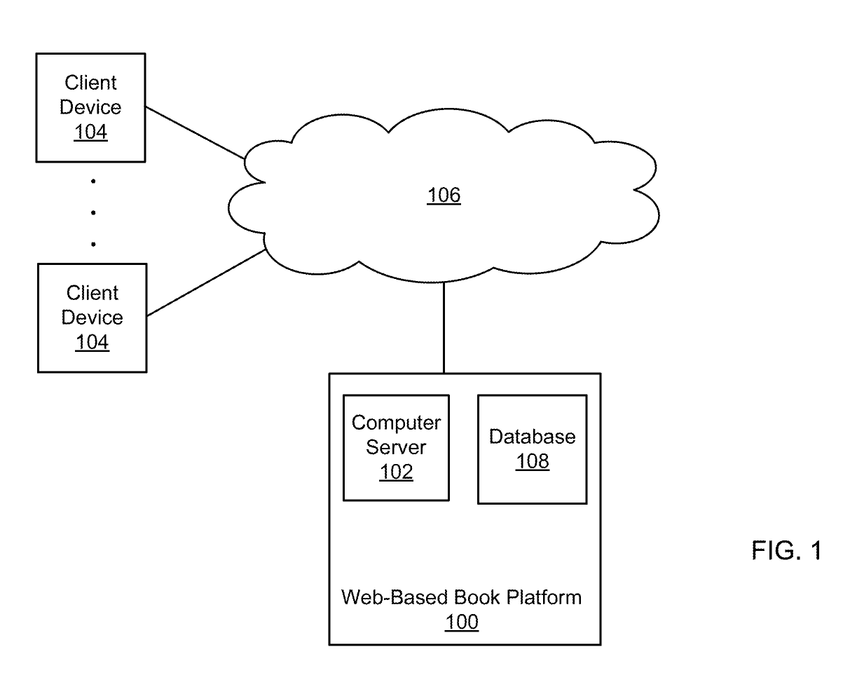

FIG. 1 illustrates an exemplary network, in which a web-based book platform 100 in accordance with one or more embodiments may be implemented. The platform 100 includes a computer server system 102, which communicates with a plurality of client devices 104 operated by the users of the platform 100. The client devices 104 communicate with the platform 100 over a communications network 106. The communications network 106 may comprise any network or combination of networks including, without limitation, the Internet, a local area network, a wide area network, a wireless network, and a cellular network.

The client devices 104 operated by users to access the platform 100 can comprise any computing device that can communicate with the computer server system including, without limitation, personal computers (including desktop, notebook, and tablet computers), smart phones, and cell phones.

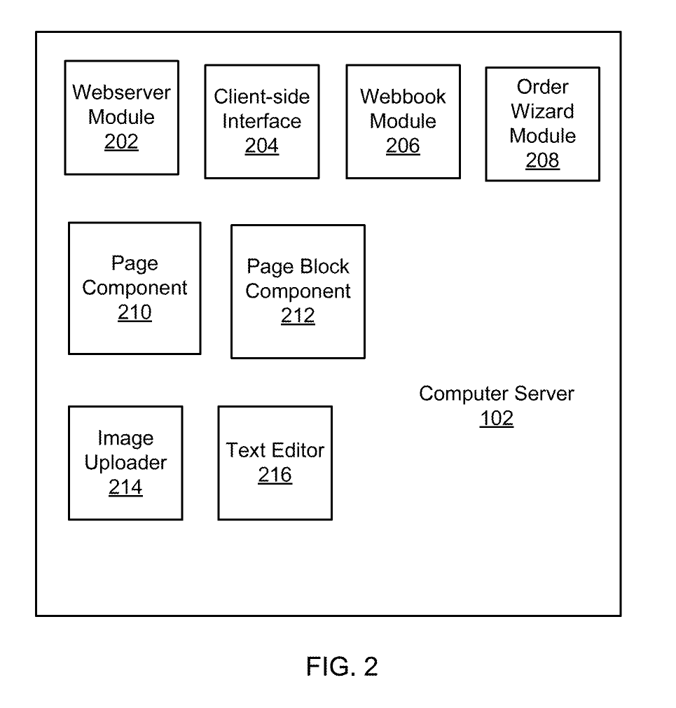

The platform 100 includes a database 108 and a flexible user-interface implemented in the computer server system 102. The user interface includes a plurality of modules shown in FIG. 2 and described in further detail below that allows users to create web-based books. Each web-based book can be dedicated to a particular subject, such as a person, place, event, group, etc. A user can search for a web-based book or a page in the book based on its particular subject. Once the user finds the book or page of interest, the user can read what other users have written and electronically flip through the pages as if the user is reading a physical book. The user also has the option of adding additional pages in that book, or even purchasing an entirely new book. If the user chooses to add pages to an existing web-based book, the book is configured to allow the user to dynamically add, delete, or edit content on those pages in real time

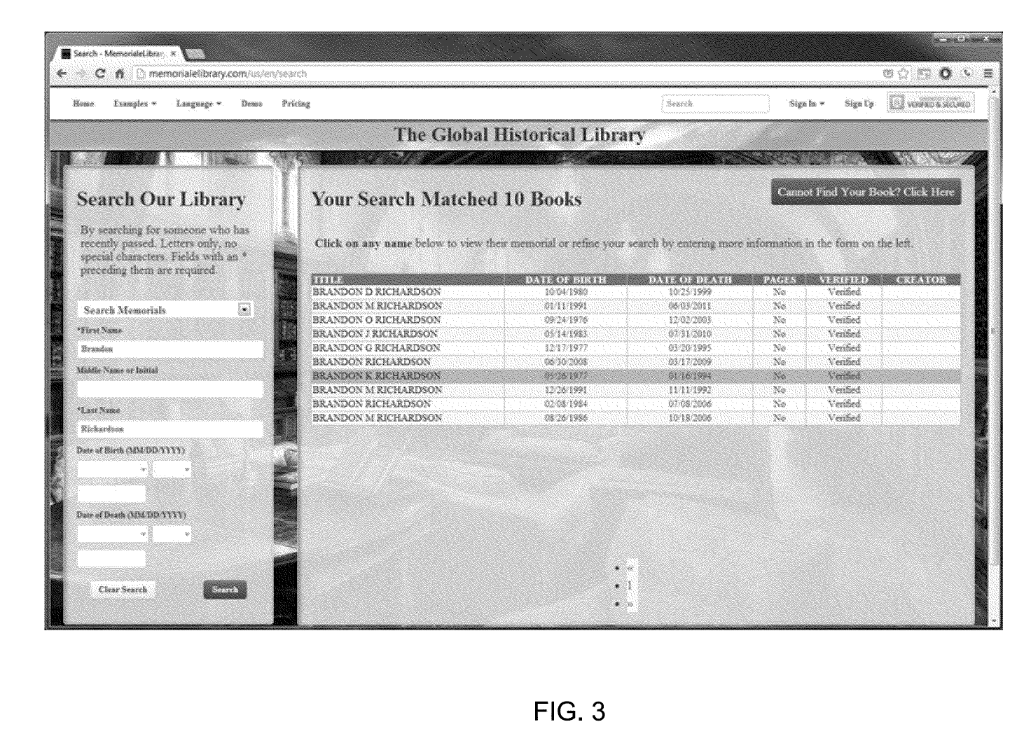

The platform's database 108 is configured to receive information, organize it, cross-reference it based on user-inputs, and provide it to the user-interface for display to the user. In one embodiment, the database 108 regularly receives information from an outside source. For example, the United States Social Security Office can provide monthly updates on recent deaths and the database 108 can update its records accordingly. In another embodiment, the staff managing the platform 100 can monitor these monthly records and update the database 108 accordingly. By keeping track of this information, the platform 100 can allow a user to search for a deceased person by name if the user wants to create a book in the deceased's memory. FIG. 3 is a screenshot illustrating one example of a set of results shown to a user conducting such a search. The database 108 also receives information that the users are inputting on their pages and into their books. This type of information is virtually unlimited, and can include data on people (e.g., family, friends, and historical figures), places (e.g., landmarks and places of interest), geographical locations, events (e.g., historical events, current events, and personal events), and relationships (e.g., genealogy, historical links, and friendships).

In order to organize the information based on shared relationships, the database 108 contains associated tables for detailed lookups and cross references. This structure allows users to link their pages to other entities that exist in the database 108, such as people, places of interest, events, locations, etc. By linking entities, the database 108 can organize the information, map relationships between entities, and display these relationships in various graphical formats. For example, a user could create a web-based book for Harold Schwaerzle, who was a member of The United States Marine Corps during World War II, and fought in The Battle of Guadalcanal. Based on these subjects, there would be three entities that could be linked to one another in the database 108: Harold Schwaerzle, The United States Marine Corps, and Guadalcanal. Each entity could then have a book devoted to it to detail the history of that entity. The link associations between these three entities would allow users to query relations across the entire database for further information. For example, a user could search the database 108 for all of the United States Marines who served with Harold Schwaerzle at the Battle of Guadalcanal. Assuming that web-based books had been created for these particular Marines, the platform 100 would return all of the matches and allow a user to select an individual Marine's book and read all of its entries.

If a user wants to add an entity that does not already exist, the database 108 will create the new entity and allow the user, as well as all other users, to link to the newly created entity. This design allows the database 108 to grow exponentially as it accumulates information and relationships from users around the world.

Even though the present embodiment describes use of the web-based book for historical purposes, one of ordinary skill in the art would understand that the web-based book may be embodied in other forms without departing from the spirit or essential characteristics thereof. For example, an alternative use can be as a guest book to provide congratulatory messages for a wedding, or condolences for a funeral. In another embodiment, the web-based book can be used to share general information, such a vacation photos, recipes, or blogs. In yet another embodiment, the web-based book can be used to share future information such as vacation plans, sporting events, etc. to elicit feedback, comments, or suggestions from other users. In another embodiment, the web-based book could be used to advertise information, such as apartment listings or items to be sold. In yet another embodiment, the web-based book can be used as a teaching tool to distribute lesson plans or class notes to students. In another embodiment, the web-based book can be used as a religious tool to distribute sermons or lectures to followers. Over time, the database 108 will increase with each entity and relationship link provided by a user, thereby creating an expansive library of information that contains information about people and their relations to places and events in the past, present and future.

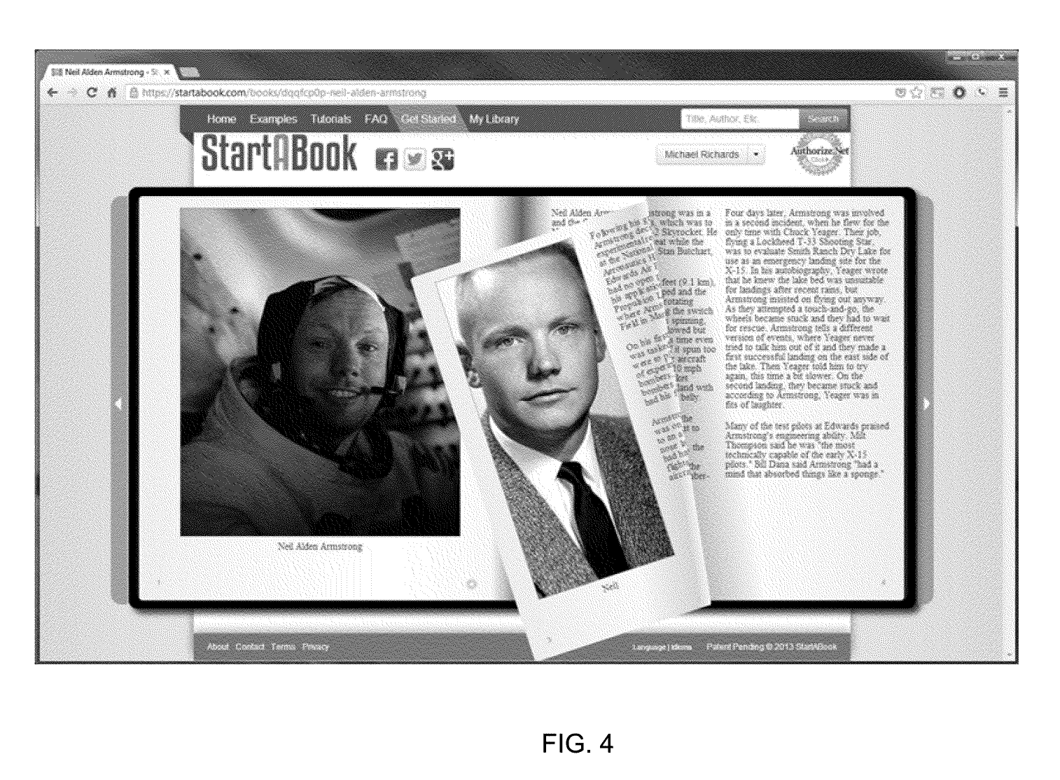

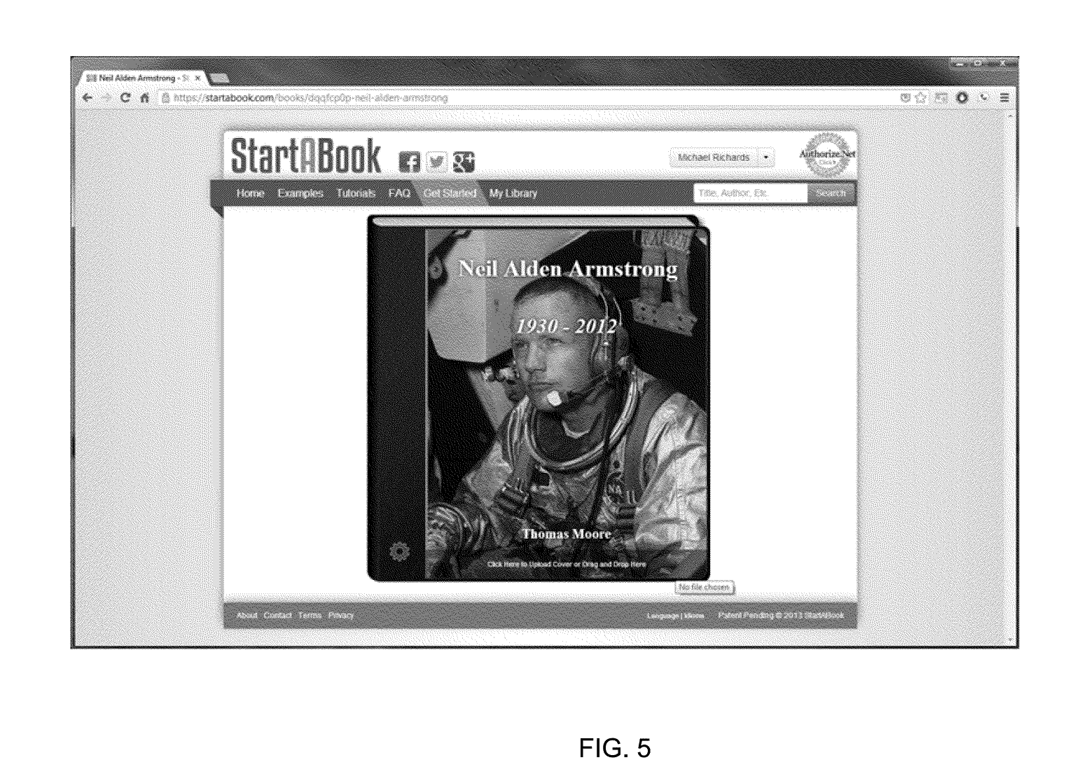

In order to selectively display the organized and cross-referenced data in the database 108, the platform 100 includes a user-interface that provides a web-based simulation of a book, which includes pages that can be electronically turned by the user, as shown by way of example in the screenshot of FIG. 4. In one embodiment, the book can include front and back covers. FIG. 5 is a screenshot illustrating one example of a front book cover. Each page of the book is configured to dynamically display text, images, and media (including video) in real-time. All of this data is stored in the database 108 so that a user can search for any book of interest from the virtual library and interact with it as if it were a physical object.

In one or more embodiments, a user can add or purchase additional pages in an existing book. Each of these pages is configured so that the user can dynamically add, upload, delete, and edit content on the page in real-time. This feature is a significant improvement over existing web-based books, which can only display static content once the book has been constructed in the browser. The dynamic nature of this new user-interface allows a user to add content to pages using various methods such as: browsing for files and inputting them onto the page; copying and pasting content onto a page; and dragging and dropping content onto the page. The user-interface also has features such as: in-place editing of content on a page; automatic resizing as the browser window resizes and scaling content proportionately; cropping images that have been uploaded to a page; and dividing an existing web-based book into chapters.

The user-interface is constructed with a unique solution based on several modules coded in HTML and Javascript that work together to produce the web book interface. As shown in FIG. 2, these components include: a webserver module 202, client-side interface 204, webbook module 206, order wizard module 208, page component 210, page block component 212, image uploader 214, and text editor 216. Among other things, these components control: loading the cover and book design; uploading text and media content; adding chapters and pages to an existing web-based book; dragging and dropping picture uploads; interaction with the payment gateway when the user purchases a new book or additional pages in an existing book; editing page text; supporting chapters owned by different authors in the same book; organizing various page layouts; and storing data from multiple authors.

The webserver module 202 renders a webpage that includes the initial HTML structure of the book and serves this page to the web browser. The webserver module 202 also provides an HTTP REST API that allows for the retrieval and updating of data structures asynchronously via Javascript as the viewer interacts with the web-based book.

The client-side interface 204 includes several components, each responsible for tracking its own state, enabling and disabling various user interactions based on the current state, and for displaying and sometimes animating transitions from one state to another.

The webbook module 206 is responsible for displaying either the cover of the web book or the open-book contents, sizing and resizing base font metrics as the window is resized, and interacting with the client-side book and page management code. The webbook module 206 also maintains and animates a collection of pages, and keeps track of the current location displayed through the user-interface.

Users can change the cover of their book by providing an image to display. The process of uploading and cropping a cover image is the same as the one used to upload images inside the book pages. The user's image is then layered between other images that contain transparent areas, allowing it to show through in a seamless way, appearing as part of a book cover. Title, subtitle, and author name text is overlaid on top, and the entire set of images and text animates and resizes as a single unit.

The order wizard module 208 is responsible for displaying and navigating through a purchasing process, allowing the user to purchase a book or buy additional pages to add to a book.

The page component 210 is responsible for managing a particular page in the book, allowing the user who owns that page to edit the content displayed. This component manages a collection of page block components 212.

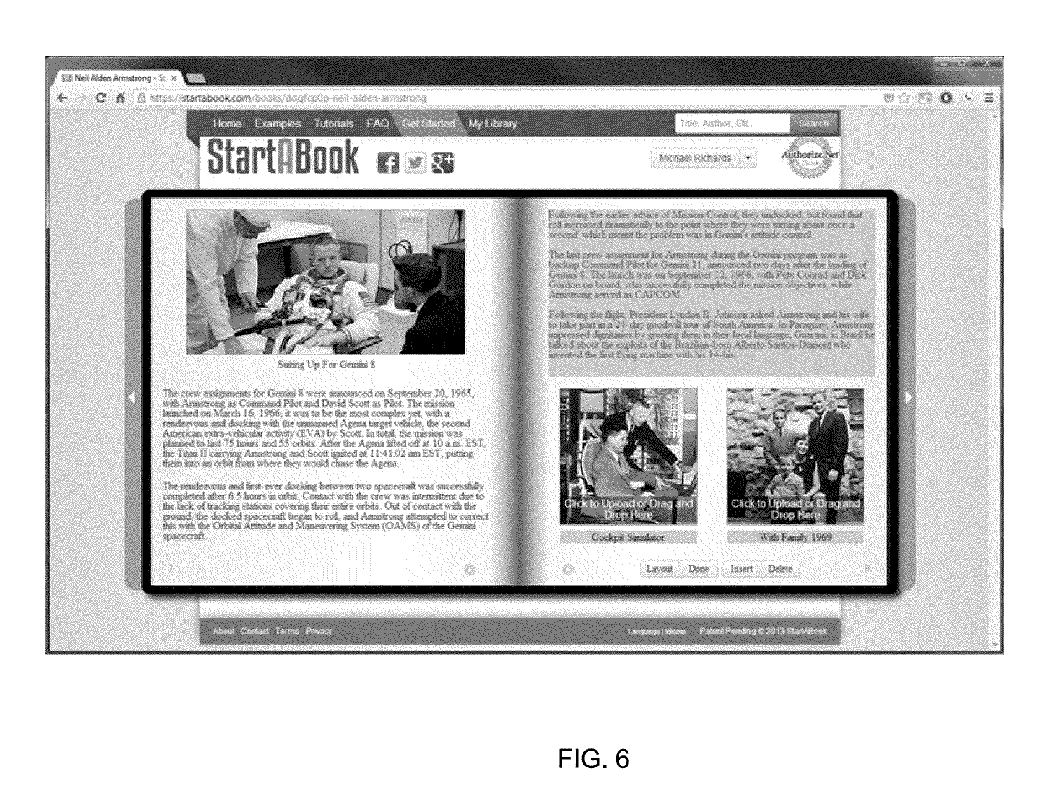

The page block component 212 covers an area of the displayed webbook page in which user-supplied content can be displayed and edited. Each page block can either be in a display state or an editable state based on the editable state of its parent page component 210. FIG. 6 is a screenshot illustrating two exemplary pages in a webbook. The page on the left (page 7) is in a display state, and the page on the right (page 8) is in an editable state (as indicated by the highlighting of the editable text). In one embodiment, the user can switch back and forth between the display state and edit state. Page blocks also provide the information needed by various editing components to address a specific user-content resource when interacting with the back-end server API. When switching from display to edit mode, the page block component 212 also creates any editing components needed, and then destroys them when the page block component 212 switches back to the display mode. FIG. 6 illustrates examples of such editing components as indicated by the buttons for “Layout,” “Done,” “Insert,” and “Delete.”

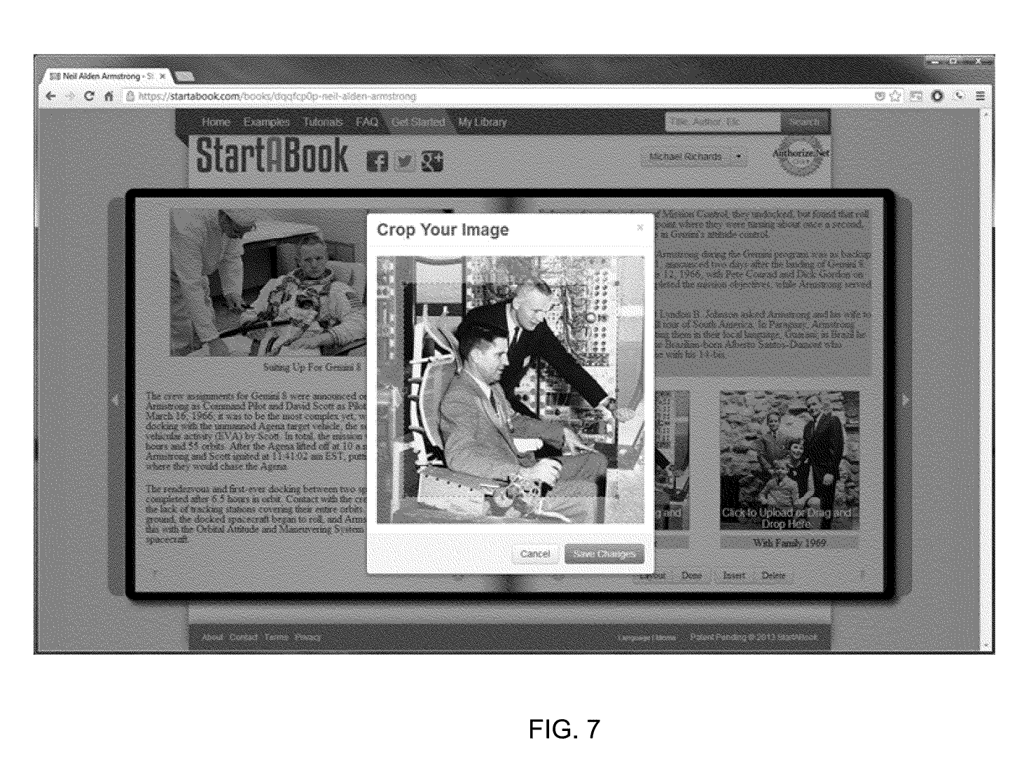

The image uploader 214 provides an interface to asynchronously upload or re-upload an image to a page in the web book or to its cover. In one embodiment, this can be achieved either by a file selection dialog provided by the browser or by dragging and dropping an image file from the file system. Once uploaded, an in-page image cropping dialog is shown, prompting the user to crop the image to the aspect ratio required by the parent page block as shown in the exemplary screenshot of FIG. 7. After cropping the image, the page block is notified of the change, and it loads the new image in place of the previous one. In one embodiment, the image cropping dialog and image cropping interface are separate components used by the image uploader 214, with each component being responsible for part of the image upload process.

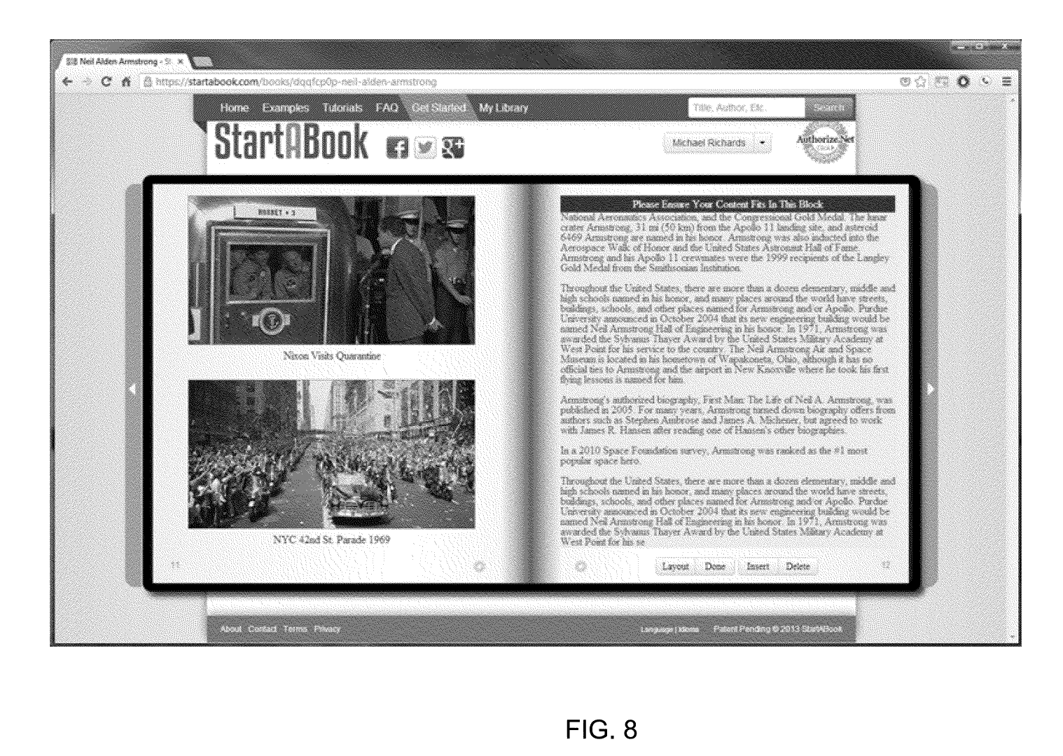

The text editor 216 component allows the user to edit text on a page, saves the user's changes periodically, and enforces size constraints on the content added to a page to ensure that the text provided will fit within the page block, as shown by way of example in the screenshot of FIG. 8.

This unique HTML-based format provides the flexibility and dynamic nature of HTML format with the renderings and animation of plug-in based architecture like JAVA and FLASH. As described above, the user-interface can render data that is indexed by search engines, can be supported by all browsers and various operating systems, and can provide real-time editing of pages in the web-based book. All of these features are typically not supported by JAVA-based or FLASH-based applications. Furthermore, the user-interface can provide renderings and animation typical of a FLASH-based book or JAVA-based book without having to refresh the browser. These features are typically not supported by HTML-based applications. Accordingly, the HTML-based solution for the user-interface helps to leverage the capabilities of both types of architectures in order to allow for a more flexible, more dynamic web-based book.

Various libraries are used on the client-side in the browser to provide various virtual book functionalities described herein. In one or more embodiments, a JavaScript based page-turn library is used to handle the organization, rendering, and animation of the pages inside a book. An image cropping library can be used to provide a user interface for selecting the crop-area of uploaded photos. A file upload handling library can be used to address cross-browser issues when users drag photos in from their computer, or click/tap an area of the book to bring up a file selection dialog box for uploading a photo. Various other libraries written in JavaScript can be used to perform other functions.

The basic markup that defines a virtual book and its content is served by the computer server to a browser on a user client device when the user requests a page that includes a virtual book. The markup is parsed by the browser, and a Document Object Model is built. References to additional resources that should be loaded are noticed, and requests are made for those resources. Such resources can include images, stylesheets, and JavaScript source files. As those resources are loaded, the browser renders the page, applying styles as they become available, and running scripts as they load.

In accordance with one or more embodiments, the platform compiles and compresses stylesheets and JavaScript source files, including the various libraries mentioned above, into several files that can be delivered quickly to the browser, and can be cached to avoid having to serve them again. These are the scripts loaded while parsing the page markup in the browser.

Once the page has loaded and rendered, the code is run and a virtual book is constructed on the page. Event handlers are attached to various elements so that they can respond to clicks, taps, drags, and other gestures made by the user.

While the web-based book is configured to be built in HTML in order to be accessible via any internet connection without the need of a plug-in, the platform 100 can be configured so that video and audio playback on a particular page may be implemented using ADOBE FLASH if the user's browser does not support a native HTML rendering of this particular media.

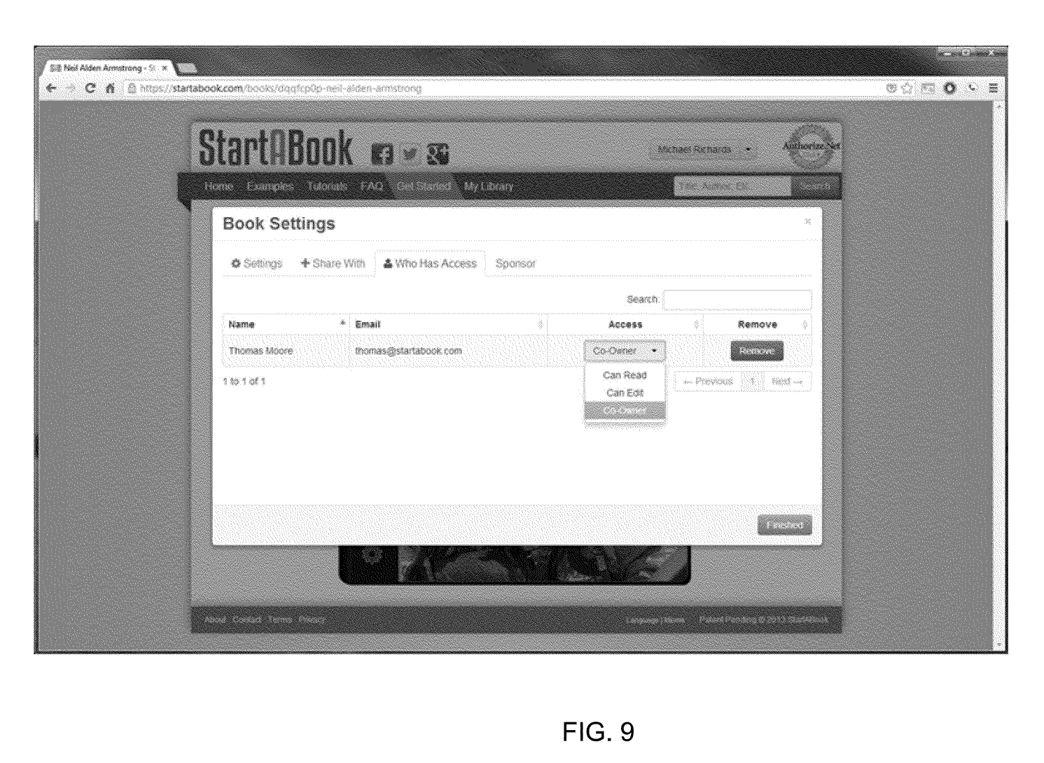

One of ordinary skill in the art would recognize that various types of privacy settings can be implemented for each web-based book, as shown by way of example in the screenshot of FIG. 9. For example, the creator of a web-based book could mandate that all other users have read-only access to the book so that no one else could add pages to it. In another embodiment, the creator of a web-based book could mandate that only a subset of users have access to either view or add pages to the book. In yet another embodiment, the creator of a web-based book could choose to avoid implementing privacy settings such that any user could view and add pages to the book.

While given components of the platform 100 have been described separately, one of ordinary skill also will appreciate that some of the functions may be combined or shared in given instructions, program sequences, code portions, and the like.

The processes of the web-based book platform 100 described above may be implemented in software, hardware, firmware, or any combination thereof. The processes are preferably implemented in one or more computer programs executing on a programmable computer (which can be part of the server computer system) including a processor, a storage medium readable by the processor (including, e.g., volatile and non-volatile memory and/or storage elements), and input and output devices. Each computer program can be a set of instructions (program code) in a code module resident in the random access memory of the computer. Until required by the computer, the set of instructions may be stored in another computer memory (e.g., in a hard disk drive, or in a removable memory such as an optical disk, external hard drive, memory card, or flash drive) or stored on another computer system and downloaded via the Internet or other network.

Having thus described several illustrative embodiments, it is to be appreciated that various alterations, modifications, and improvements will readily occur to those skilled in the art. Such alterations, modifications, and improvements are intended to form a part of this disclosure, and are intended to be within the spirit and scope of this disclosure. While some examples presented herein involve specific combinations of functions or structural elements, it should be understood that those functions and elements may be combined in other ways according to the present disclosure to accomplish the same or different objectives. In particular, acts, elements, and features discussed in connection with one embodiment are not intended to be excluded from similar or other roles in other embodiments.

Additionally, elements and components described herein may be further divided into additional components or joined together to form fewer components for performing the same functions. For example, the computer server system may comprise one or more physical machines, or virtual machines running on one or more physical machines. In addition, the computer server system may comprise a cluster of computers or numerous distributed computers that are connected by the Internet or another network.

Accordingly, the foregoing description and attached drawings are by way of example only, and are not intended to be limiting.

What is claimed is:

1. A method of creating a web-based book simulating the experience of reading a physical book, said web-based book being directly editable by a user in real-time, the method comprising the steps of:
(a) rendering a webpage of the web-based book by a server computer system in response to a request received over a communications network from a client device operated by a user, said webpage having an HTML-based format;
(b) sending the webpage to the client device to be displayed by a web browser on the client device;
(c) receiving one or more edits made by the user on the webpage; and
(d) updating the web-based book in real-time to include the edits.

2. The method of claim 1, wherein the browser on the client device does not require a plug-in to display the webpage.

3. The method of claim 1, wherein the client device comprises a desktop computer, a notebook computer, a tablet computer, a smart phone, or a cell phone.

4. The method of claim 1, wherein content in the web-based book is searchable and indexable by a search engine.

5. The method of claim 1, wherein the one or more edits comprise an addition to, a deletion of, or a change to content on the webpage.

6. The method of claim 1, wherein the one or more edits comprise in-place edits on the webpage.

7. The method of claim 1, wherein the web-based book includes page turning and content resizing functionalities.

8. The method of claim 7, wherein the page turning and content resizing functionalities are implemented in JavaScript.

9. The method of claim 1, wherein the web-based book includes content from users and content obtained from external sources.

10. The method of claim 1, further comprising conducting a search in response to a request from a user for a web-based book dedicated to a particular subject.

11. The method of claim 1, further comprising storing in a database information input by users into their web-based books, and organizing the information based on shared relationships.

12. The method of claim 11, wherein the information is organized by linking pages in each web-based book to other entities in the database.

13. The method of claim 12, further comprising mapping relationships between the entities and displaying the relationships in a graphical format.

14. The method of claim 1, wherein the web-based book includes a front cover containing content provided by the user.

15. The method of claim 14, wherein the content includes an image uploaded by the user, the method further comprising layering the uploaded image on other images in the cover such that the uploaded image is visible through transparent areas in the other images.

16. The method of claim 1, wherein the webpage includes a plurality of page blocks that can be switched by a user between a display state for viewing content on the webpage and an editable state for editing content on the webpage.

17. The method of claim 1, further comprising restricting access to the web-based book by enabling only a subset of users to view or edit the web-based book.

18. A server computer system, comprising:
at least one processor;
memory associated with the at least one processor; and
a program supported in the memory for creating a web-based book simulating the experience of reading a physical book, said web-based book being directly editable by a user in real-time, the program containing a plurality of instructions which, when executed by the at least one processor, cause the at least one processor to:
(a) render a webpage of the web-based book in response to a request received over a communications network from a client device operated by a user, said webpage having an HTML-based format;
(b) send the webpage to the client device to be displayed by a web browser on the client device;
(c) receive one or more edits made by the user on the webpage; and
(d) update the web-based book in real-time to include the edits.

19. The system of claim 18, wherein the browser on the client device does not require a plug-in to display the webpage.

20. The system of claim 18, wherein the client device comprises a desktop computer, a notebook computer, a tablet computer, a smart phone, or a cell phone.

21. The system of claim 18, wherein content in the web-based book is searchable and indexable by a search engine.

22. The system of claim 18, wherein the one or more edits comprise an addition to, a deletion of, or a change to content on the webpage.

23. The system of claim 18, wherein the one or more edits comprise in-place edits on the webpage.

24. The system of claim 18, wherein the web-based book includes page turning and content resizing functionalities.

25. The system of claim 24, wherein the page turning and content resizing functionalities are implemented in JavaScript.

26. The system of claim 18, wherein the web-based book includes content from users and content obtained from external sources.

27. The system of claim 18, further comprising instructions for conducting a search in response to a request from a user for a web-based book dedicated to a particular subject.

28. The system of claim 18, further comprising instructions for storing in a database information input by users into their web-based books, and organizing the information based on shared relationships.

29. The system of claim 28, wherein the information is organized by linking pages in each web-based book to other entities in the database.

30. The system of claim 29, further comprising instructions for mapping relationships between the entities and displaying the relationships in a graphical format.

31. The system of claim 18, wherein the web-based book includes a front cover containing content provided by the user.

32. The system of claim 31, wherein the content includes an image uploaded by the user, the system further comprising instructions for layering the uploaded image on other images in the cover such that the uploaded image is visible through transparent areas in the other images.

33. The system of claim 18, wherein the webpage includes a plurality of page blocks that can be switched by a user between a display state for viewing content on the webpage and an editable state for editing content on the webpage.

34. The system of claim 18, further comprising instructions for restricting access to the web-based book by enabling only a subset of users to view or edit the web-based book.
